(19) United States
(12) Patent Application Publication
(10) Pub. No.: US 2022/0180205 A1
(43) Pub. Date: Jun. 9, 2022

(54) MANIFOLD REGULARIZATION FOR TIME SERIES DATA VISUALIZATION

(71) Applicant: INTERNATIONAL BUSINESS MACHINES CORPORATION, Armonk, NY (US)

(72) Inventors: Abhishek Kolagunda, San Jose, CA (US); Yang Sun, Fuzhou (CN); Xiaolong Wang, Campbell, CA (US); Steven Nicholas Eliuk, San Jose, CA (US)

(21) Appl. No.: 17/115,898

(22) Filed: Dec. 9, 2020

(51) Int. Cl. G06N 3/08; G06N 3/04

(52) U.S. Cl. CPC G06N 3/088; G06N 3/0454

(57) ABSTRACT

A method for generating and displaying an embedding of multivariate time series data in an embedded space is provided. The method may include optimizing a generative deep learning neural network by adding a regularization term to train the generative deep learning neural network, wherein the regularization term maintains a temporal relationship between data points associated with the multivariate time series data when representing the data points of the multivariate time series data in an embedded space. The method may further include, in response to receiving the multivariate time series data, applying the optimized generative deep learning neural network to the input, and representing and displaying the multivariate time series data in the embedded space such that the temporal relationship between the data points from the input is captured by and presented in the representation, wherein the representation comprises an embedding of the multivariate time series data in the embedded space.

### BACKGROUND

The present invention relates generally to the field of computing, and more specifically, to time series data visualization.

Generally, a time series is a series of data points indexed (or listed or graphed) in time order. Most commonly, a time series may include snapshots of a sequence that is taken at successive equally spaced points in time. As such, time series data analysis may be useful to see how a given data point, asset, security or economic variable changes over time. Examples of time series data may include sensor data associated with an internet of things (IoT) device, daily weather data, and the daily closing value of the Dow Jones Industrial Average. Multivariate data visualization is a type of time series data visualization where multiple data dimensions or attributes may be analyzed and represented. As such, a multivariate time series has more than one time-dependent variable. Each variable may not only depend on its past values but also has some dependency on other variables. This dependency is used for forecasting future values. Thus, multivariate analysis may involve determining potential relationships, patterns and correlations amongst these variables/attributes. Multivariate time series data analysis is a popular tool due to its widespread and popular application to fields ranging from health and medicine, market and online retail, weather, security, infrastructure, biology and others. The increase in utilizing multivariate time series data can be attributed to the improvements in sensor and data collection infrastructure and growing utilization of multivariate time series data in classification, forecasting, and anomaly detection related applications.

### SUMMARY

A method for generating and displaying an embedding of multivariate time series data in an embedded space is provided. The method may include optimizing a generative deep learning neural network model by adding a regularization term to train the generative deep learning neural network model in an optimization process, wherein the regularization term maintains a temporal relationship between data points associated with the multivariate time series data when representing the data points of the multivariate time series data in an embedded space. The method may further include, in response to receiving the multivariate time series data, applying the optimized generative deep learning neural network model to the input, and representing and displaying the multivariate time series data in the embedded space such that the temporal relationship between the data points from the input is captured by and presented in the representation, wherein the representation comprises an embedding of the multivariate time series data in the embedded space.

A computer system for generating and displaying an embedding of multivariate time series data in an embedded space is provided. The computer system may include one or more processors, one or more computer-readable memories, one or more computer-readable tangible storage devices, and program instructions stored on at least one of the one or more storage devices for execution by at least one of the one or more processors via at least one of the one or more memories, whereby the computer system is capable of performing a method. The method may include optimizing a generative deep learning neural network model by adding a regularization term to train the generative deep learning neural network model in an optimization process, wherein the regularization term maintains a temporal relationship between data points associated with the multivariate time series data when representing the data points of the multivariate time series data in an embedded space. The method may further include, in response to receiving the multivariate time series data, applying the optimized generative deep learning neural network model to the input, and representing and displaying the multivariate time series data in the embedded space such that the temporal relationship between the data points from the input is captured by and presented in the representation, wherein the representation comprises an embedding of the multivariate time series data in the embedded space.

A computer program product for generating and displaying an embedding of multivariate time series data in an embedded space is provided. The computer program product may include one or more computer-readable storage devices and program instructions stored on at least one of the one or more tangible storage devices, the program instructions executable by a processor. The computer program product may include program instructions to optimizing a generative deep learning neural network model by adding a regularization term to train the generative deep learning neural network model, wherein the regularization term maintains a temporal relationship between data points associated with the multivariate time series data when reconstructing the data points of the multivariate time series data in an embedded space. The computer program product may further include program instructions to, in response to receiving the multivariate time series data as input, apply the optimized generative deep learning neural network model to the input, and represent and display the multivariate time series data in the embedded space such that the temporal relationship between the data points from the input is captured by and presented in the representation, wherein the representation comprises an embedding of the multivariate time series data in the embedded space.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to one embodiment;

FIG. 2 is a visual representation of input data and an example of reconstruction of the input data according to one embodiment;

FIG. 3 is an exemplary diagram illustrating the variational autoencoder (VAE) formula and application of the proposed manifold regularization term to the VAE according to one embodiment;

FIG. 4 is an exemplary diagram illustrating network architecture associated with a manifold regularization program according to one embodiment;

FIG. 5 is an illustrative diagram of overlapping, sliding time windows applied to multivariate time series data according to one embodiment;

FIG. 6 is an exemplary plotting techniques for visualizing multivariate time series data according to one embodiment;

FIG. 7 is a block diagram of the system architecture of the program for optimizing a neural network architecture by estimating an inference time for operators in the neural network architecture according to one embodiment;

FIG. 8 is a block diagram of an illustrative cloud computing environment including the computer system depicted in FIG. 1, in accordance with an embodiment of the present disclosure; and

FIG. 9 is a block diagram of functional layers of the illustrative cloud computing environment of FIG. 8, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

As previously described, embodiments of the present invention relate generally to the field of computing, and more particularly, to time series data visualization. Specifically, the following described exemplary embodiments provide a system, method and program product for generating and displaying an embedding of multivariate time series data in an embedded space. More specifically, the present invention has the capacity to improve the technical field associated with time series data visualization by optimizing a generative deep learning neural network model by adding a regularization term to the generative deep learning neural network model such that the regularization term maintains a temporal relationship between data points associated with the multivariate time series data when reconstructing the data points of the multivariate time series data in an embedded space. Then, in turn, the optimized generative deep learning neural network model may be used to effectively parse and visualize different patterns and anomalies in the multivariate time series data.

Specifically, and as previously described with respect to multivariate time series data, multivariate time series data analysis is a popular tool due to its widespread and popular application ranging from healthcare, retail, weather, security, and infrastructure. However, the wide use of multivariate time series data has also brought challenges in trying to parse long sequences, in its raw form, to identify patterns and create labeled data for different modeling approaches. Generally, typical approaches to analyze such data involve transforming the data into a representation that is compact (reduced dimensionality) and efficiently preserves the information. For most time series data, a data value at a given time point, by itself, does not carry as much useful information as it would when analyzed in the context of its neighboring time values. Summarizing time windows may also help reduce the data noise for useful information extraction. Naive approaches to summarize overlapping windows of contiguous data involves symmetric functioning, like average, sum, min, max, etc. Principal Component Analysis (PCA) is also widely used to summarize the relation between variables in stationary data with limited time series. In addition, transforming the time series data to frequency domain, via Fast Fourier Transform, is another solution. However, it is not trivial to extend these kind of approaches to a multivariate time series data analysis problem. Since 2012, deep neural networks have achieved lots of successes in artificial intelligence community, especially in natural language understanding and computer vision areas. The learned representations via deep neural networks have demonstrated tremendous successes in various tasks such as classification, generation, detection, translation, etc.

Deep neural networks can be categorized into discriminative and generative models. Compared to discriminative learning models, which heavily rely on labeled data, generative models are more flexible in terms of label quality. This has made it popular in image generation, reinforcement learning, and semi-supervised learning tasks. Due to its powerful learning capability, deep neural networks demonstrate great potential for non-linear dimensionality reduction of multivariate data. Among these different generative models, Variational Autoencoder (VAE) has become a prevailing methodology for presenting a rich representation, or modeling, time series data. Specifically, the VAE is a class of deep neural network generative models that have been used to learn a concise representation of input data while minimizing data loss when reconstructing the input data in an embedded space. Thus, the VAE may be used as the deep neural network basis to summarize contiguous blocks of multivariate time series data by learning the compact latent representation of the input multivariate time series data. However, directly applying the VAE to the multivariate time series data may not capture temporal characteristics of the contiguous time sequential data blocks. Specifically, for example, when analyzing the input multivariate time series data, the VAE does not care if two data points are next to each other in a time sequence, and in turn, reconstruction (representation) and embedding of data points in an embedding space (i.e. a reduced dimensionality) using the VAE may be unrelated even if two consecutive data points are in consecutive time sequence in the input data. In turn, when using the VAE to summarize contiguous blocks of the multivariate time series data, samples of the multivariate time series data that belong to nearby time windows may be displayed discretely, or separate, in an embedding space and lose the continuity that was observed in the input data. Therefore, it then becomes a problem to visualize this embedded multivariate time series data to look for patterns in the data as temporal continuity may be lost in the embedded space.

As such, it may be advantageous, among other things, to provide a method, computer system, and computer program product for generating and displaying a smooth representation of an embedding of multivariate time series data using a variational autoencoder (VAE) along with a manifold regularization term. More specifically, the method, computer system, and computer program product may optimize the variational autoencoder (VAE) by introducing a manifold regularization term in the VAE in order to generate the smooth representation, whereby generating the smooth representation of the embedding includes displaying a more temporal relationship/connection between data points associated with the multivariate time series data in an embedded space, which in turn, can be used to effectively parse and visualize different patterns and anomalies in the data. Therefore, the manifold regularization term may be used to visually and temporally correlate time series data in an embedded space and help detect changes in the time series data.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

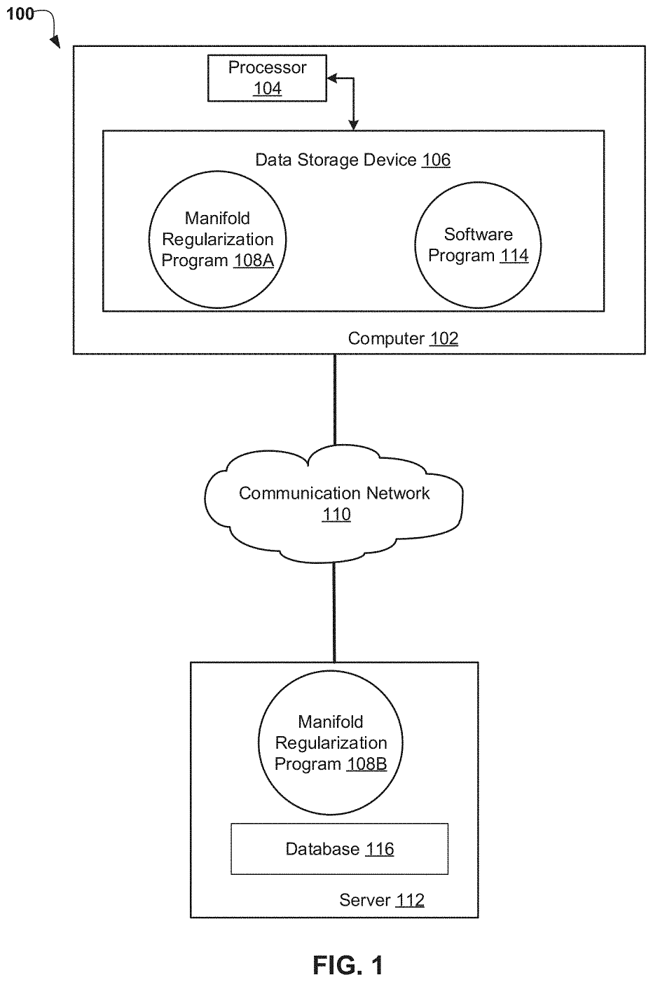

Referring now to FIG. 1, an exemplary networked computer environment 100 in accordance with one embodiment is depicted. The networked computer environment 100 may include a computer 102 with a processor 104 and a data storage device 106 that is enabled to run a manifold regularization program 108A and a software program 114, and may also include a microphone (not shown). The software program 114 may be a program such as a variational autoencoder (VAE) program, deep learning neural network program, a machine learning program, and/or one or more data mining programs running on a client computer 102, such as a desktop, laptop, tablet, and mobile phone device. The manifold regularization program 108A may communicate with the software program 114. The networked computer environment 100 may also include a server 112 that is enabled to run a manifold regularization program 108B and the communication network 110. The networked computer environment 100 may include a plurality of computers 102 and servers 112, only one of which is shown for illustrative brevity. For example, the plurality of computers 102 may include a plurality of interconnected devices, such as the mobile phone, tablet, and laptop, associated with one or more users.

According to at least one implementation, the present embodiment may also include a database 116, which may be running on server 112. The communication network 110 may include various types of communication networks, such as a wide area network (WAN), local area network (LAN), a telecommunication network, a wireless network, a public switched network and/or a satellite network. It may be appreciated that FIG. 1 provides only an illustration of one implementation and does not imply any limitations with regard to the environments in which different embodiments may be implemented. Many modifications to the depicted environments may be made based on design and implementation requirements.

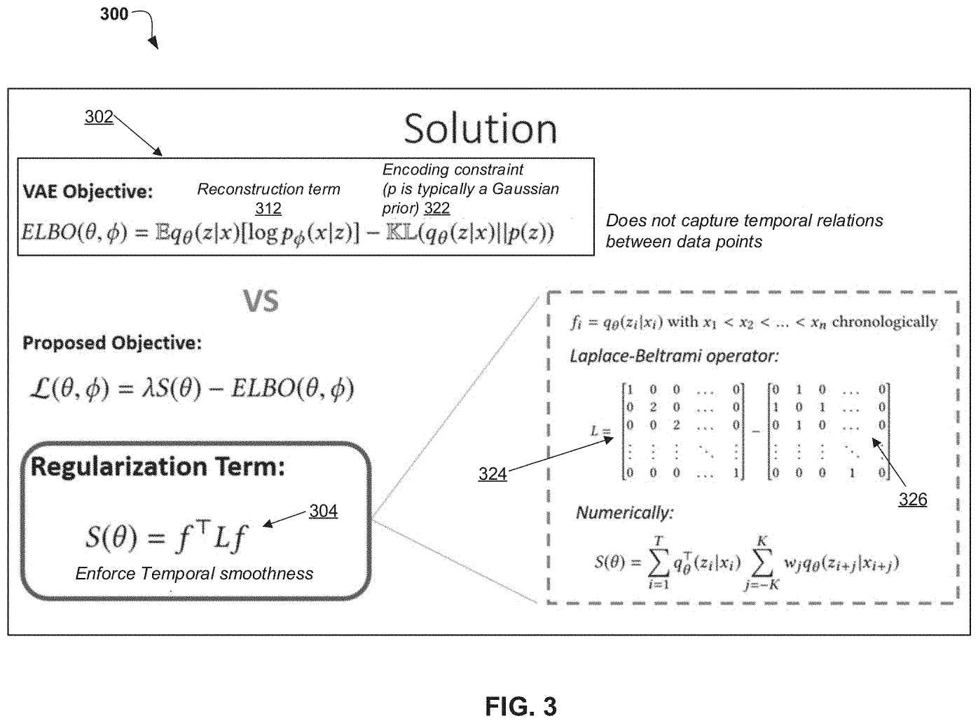

The client computer 102 may communicate with server computer 112 via the communications network 110. The communications network 110 may include connections, such as wire, wireless communication links, or fiber optic cables. As will be discussed with reference to FIG. 3, server computer 112 may include internal components 800a and external components 900a, respectively, and client computer 102 may include internal components 800b and external components 900b, respectively. Server computer 112 may also operate in a cloud computing service model, such as Software as a Service (SaaS), Platform as a Service (PaaS), or Infrastructure as a Service (IaaS). Server 112 may also be located in a cloud computing deployment model, such as a private cloud, community cloud, public cloud, or hybrid cloud. Client computer 102 may be, for example, a mobile device, a telephone, a personal digital assistant, a netbook, a laptop computer, a tablet computer, a desktop computer, or any type of computing device capable of running a program and accessing a network. According to various implementations of the present embodiment, the manifold regularization program 108A, 108B may interact with a database 116 that may be embedded in various storage devices, such as, but not limited to, a mobile device 102, a networked server 112, or a cloud storage service.

According to the present embodiment, a program, such as a manifold regularization program 108A and 108B may run on the client computer 102 and/or on the server computer 112 via a communications network 110. The manifold regularization program 108A, 108B may optimize a variational autoencoder (VAE) by applying a manifold regularization term to learn a representation of time series data and generate a temporally smooth reconstruction of the time series data for visualization in an embedded space. Specifically, a user using a client computer 102, such as a laptop device, may run a manifold regularization program 108A, 108B that may interact with a software program 114, such as a deep learning neural network program, to receive input data (such as multivariate time series data), apply a regularized-VAE to the input data, whereby the regularized-VAE includes the VAE with a manifold regularization term, to generate and display an efficient representation of the multivariate time series input data in an embedded space such that a temporal relationship/connection (i.e. smoothness) between data points in the multivariate time series data is detected and maintained when reconstructing the multivariate time series data in the embedded space.

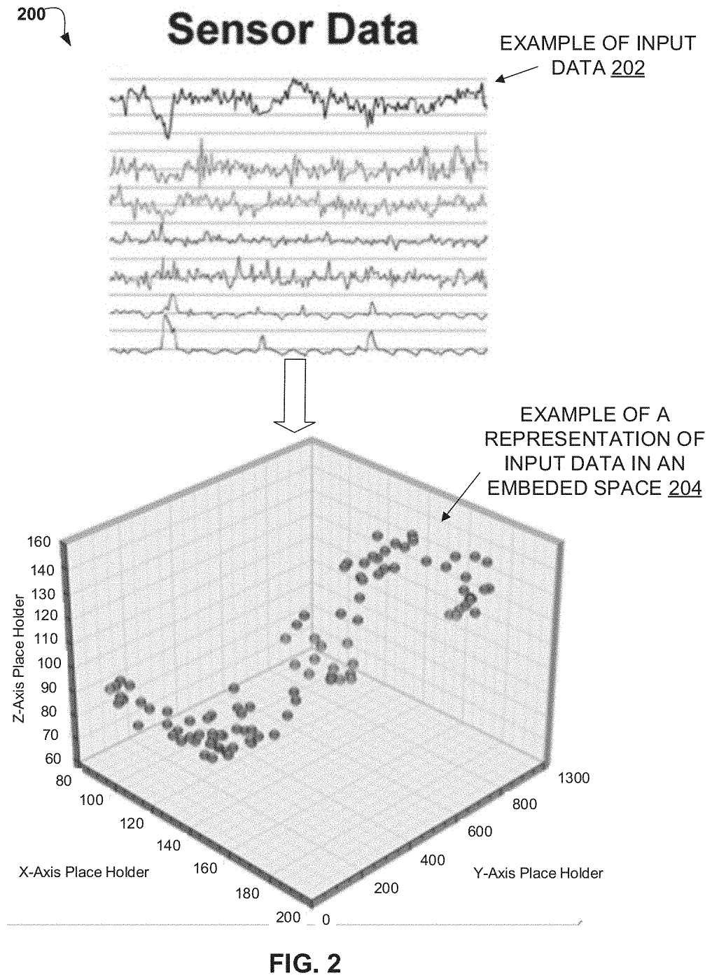

Referring now to FIG. 2, a visual representation of raw input data 202 and an example a reconstruction of the raw input data 202 in an embedded space 204 is depicted. As previously described, typical approaches to mining and analyzing useful information from large/long multivariate time series data in its raw form may involve transforming the input data into a visual representation that is compact (i.e. reduced dimensionality) and that efficiently preserves information from the input data 202 upon transformation. For example, the input data may include sensor data 202 that is monitored/collected over a period of time (for example, a 3-month period), and the reconstruction may include a process whereby the sensor data 202 may be compressed, and a deep neural network generative model (such as a VAE) may be used to learn the representation of the data in order to recreate/reconstruct the data in an embedded space 204 for better analysis.

Referring now to FIG. 3, a diagram 300 illustrating the variational autoencoder (VAE) formula 302 and application of the proposed manifold regularization term 304 to the VAE 302 according to one embodiment is depicted. As previously described, the variational autoencoder (VAE) is a deep learning neural network generative model that may be used to learn raw input data while minimizing data loss when reconstructing the input data. Specifically, according to one embodiment, the VAE 302 may include a reconstruction term 312 and an encoding restraint 322. More specifically, the reconstruction term 312 in the VAE 202 may be used to learn enough information about the raw input data 302 to reconstruct the data. For example, the input data may include sensor data from, for example, an internet of things device (IoT) device. As such, the reconstruction term 312 associated with the VAE 302 may be used to learn enough information about the sensor data to reconstruct the sensor data, for example, in an embedding space. Furthermore, the VAE 302 may use the encoding restraint 322 to, for example, place a constraint on the embedding space associated with the embedded reconstruction of the input data. For example, the encoding restraint 322 may be based on Gaussian distribution.

However, and as previously described, when dealing with multivariate time series data, the VAE model 302 may not take into account the continuity or time order of the inputted multivariate time series data, and therefore, does not capture temporal relationships between data points. For example, the input data may include snapshots of the sensor data at 2 consecutive data time sequences or points. However, when receiving this sensor data, the VAE 302 may not care if two data points are next to each other in a time sequence, and in turn, the reconstruction of the data may be represented and embedded randomly in the embedded space. Conversely, the manifold regularization program 108A, 108B may take into account that a data value at a given time point, by itself, does not carry as much useful information as it would when the data value is analyzed in the context of its neighboring time values. Therefore, the manifold regularization program 108A, 108B may optimize the VAE formula 202 by introducing a manifold regularization term 304 in the VAE 202 model such that there is a temporal smoothness to the displayed reconstructed data in the embedding space, whereby the temporal smoothness represents the temporal relationship/connection between the data points. Specifically, the manifold regularization program 108A, 108B may apply the VAE 302 along with the manifold regularization term 304 (a regularized-VAE) to learn a representation of the input data such that data points from consecutive time sequences are temporally smooth in the reconstruction of the data in an embedded space, whereby the data points are represented in the embedded space in a way that indicates a temporal relationship between the data points. In turn, the reconstructed data in the embedded space may be represented in such a way that is easier to parse, identify patterns, create labeled data for supervised modeling approaches, and to summarize and explain anomalies.

Formulation of the regularized-VAE (i.e. the VAE with the manifold regularization term included) according to an embodiment of the present invention will now be described in greater detail with respect to FIG. 3. Generally, the variational autoencoder (VAE) may model the generative process of the observed input data from its latent representation. More specifically, the VAE defines a joint probability over the input data represented by the formula:

x∈ [symbol] ^{m×n},

and the latent representation,

z∈ [symbol] ^{k}(m×n>>k),P(x,z)=P(x|z)P(z)
where, the first term on the right-handed side (RHS) is the likelihood of x and the second term is the prior of the latent variable z.

Given the observed data x, the variational autoencoder approximates the posterior P(z|x) via the encoder model and the likelihood P(x|z) via a generative model (decoder), for the decoder the latent variable z is drawn from the prior P(z). To learn the parameters of the encoder and the decoder models, the KL divergence between the variational posterior Q(z|x) and true posterior P(z|x) is minimized by maximizing the equivalent Evidence Lower BOund (ELBO).

ELBO(θ,ϕ)= [symbol] q_{θ}(z|x)[log p_{ϕ}(x|z)]− [symbol] (q_{θ}(z|x)∥p(z)) (1)
where, qθ (z|x) and pϕ(x|z) represent the encoder and decoder models respectively, and p(z) is an origin centered unit normal distribution.
   The manifold regularization program 108A, 108B may adapt the VAE architecture to encode time series data. The inputs xi for the VAE may be based on overlapping, sliding time windows of sequential data in the time series data. To adopt the manifold regularization in the encoding, the manifold regularization program 108A, 108B may define a Laplacian-Beltrami operator acting on the encoded sequence data zi as:

L=D−A (2)
where D is the degree matrix 324 and A is the adjacency matrix 326.
   Since the time sequence data is connected from head to tail, the degree matrix 324 and adjacency matrix 326 have simple forms as represented in FIG. 3. The manifold regularization program 108A, 108B may then add the manifold regularization term on top of the VAE loss as:

S(θ)=f^{T}Lf (3)
where f is the latent space of time sequence data points chronologically ordered, that is fi=qθ (zi|xi) with x1<x2< . . . <xn chronologically, and
where qθ is the encoder of VAE.
   By plugging in the numerical value of the Laplacian, the manifold regularization program 108A, 108B obtains:

$$S ( θ ) = {\sum }_{i = 1}^{T} {q}_{θ}^{⊤} ( {z}_{i} \vert {x}_{i} ) {\sum }_{j = - K}^{K} {w}_{j} {q}_{θ} ( {z}_{i + j} \vert {x}_{i + j} ) \qquad ( 4 )$$

where, w is the 1D Laplacian filter of length (2K+1).
   Combined together the loss for training the regularized-VAE model can be written as:

[symbol]

(θ,ϕ)=λS(θ)−ELBO(θ,ϕ) (5)
where λ is the weight term used to balance the losses.
   Thus, by adding the manifold regularization S(θ) to a traditional VAE loss, the manifold regularization program 108A, 108B may enforce temporal consistency between neighboring, sliding time windows for learning a temporal connections between data points, and in turn, reconstructing data in an embedded space in a temporally smooth manner.

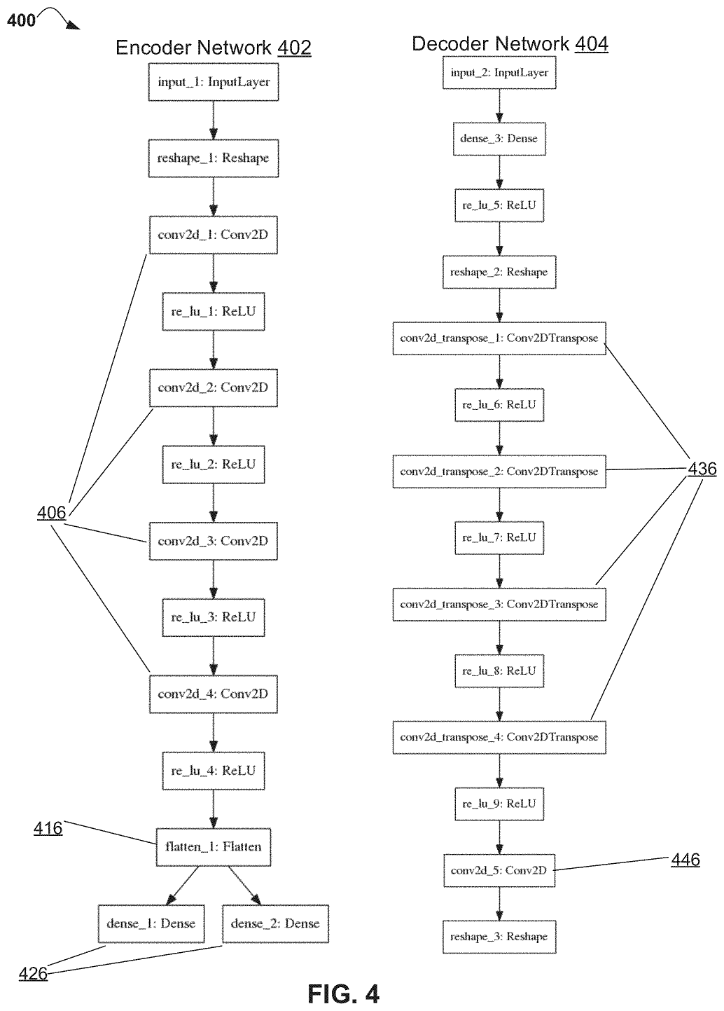

A detailed description of a network architecture 400 associated with the manifold regularization program 108A, 108B according to one embodiment is depicted in FIG. 4. Specifically, the manifold regularization program 108A, 108B may represent time series data as:

X∈ [symbol] ^{M×N}
where M is a number of monitored metrics/features and N is a number of data time points associated with the input data.

The manifold regularization program 108A, 108B may include an encoder network 402 that is composed of 4 strided 2D convolution layers 406 with ReLU activation followed by a flatten layer 416 and 2 fully connected layers 426. Each convolution layer uses filters' size (1, 3, c) where c is a channel depth of an input feature to the convolution layer. The output of the last dense layer is split into 2 parts—zμ, the mean of the embedding and the variance, as well as z|σ, the natural logarithm of the variance. The manifold regularization program 108A, 108B may also include a decoder network 404 composed of a fully connected layer followed by 4 strided de-convolution layers 436 and a 2D convolution layer 446 with filter size (1, 1, c) where c is the channel depth of the input feature to the convolution layer. All layers except the last layer uses ReLU as the activation. Each de-convolution layer uses a filter size of (1, 3, c) where c is the channel depth of the input feature to the layer. The output of the last layer includes a reconstruction of the input data represented by:

X′∈ [symbol] ^{M×N}

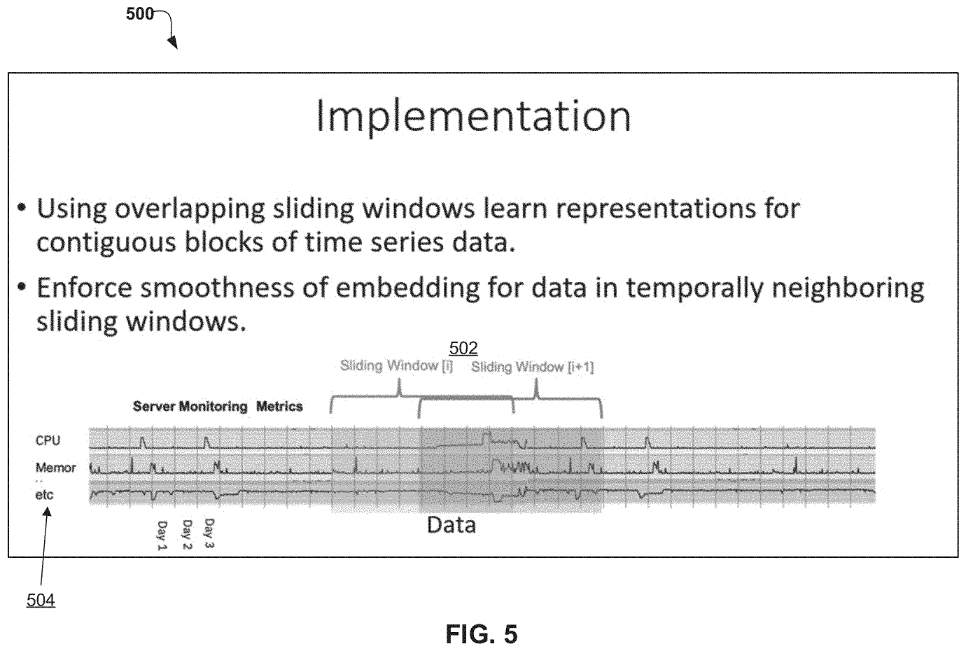

In turn, the manifold regularization program 108A, 108B may train the regularized-VAE model using overlapping time series windows. As previously described, the manifold regularization program 108A, 108B may use the regularized-VAE to analyze multivariate time series data using overlapping, time sliding windows on sequentially monitored data. An illustration 500 of overlapping, sliding time windows 502 applied to multivariate time series data is depicted in FIG. 5. For example, the manifold regularization program 108A, 108B may obtain monitoring data 504 of one or more computer servers that may run a variety of applications on different operating systems. Specifically, the manifold regularization program 108A, 108B may monitor one or more metrics/features 504 associated with the one or more computer servers whereby the number of monitored metric/features may depend on a type of operating system running on the one or more computer servers. Furthermore, the manifold regularization program 108A, 108B may collect the monitoring data for a computer server based on a configured time period, such as every 15 minutes continually for a three-month period. Accordingly, the manifold regularization program 108A, 108B may use overlapping sliding windows 502 to learn a representation of contiguous blocks of time series data. As such, by learning a representation of contiguous blocks of time series data, the manifold regularization program 108A, 108B may enforce temporal smoothness in an embedding that includes data based on temporally neighboring (or overlapping) sliding windows 502, and in turn, the embedding may visually represent and correlate anomalies and changes in patterns associated with the multivariate time series data for the computer server performance metrics.

In turn, the manifold regularization program 108A, 108B may use the trained regularized-VAE model to summarize and visualize multivariate time series data. Specifically, for example, the manifold regularization program 108A, 108B may use the trained regularized-VAE model and one or more plotting techniques (such as a 3-Dimensional graph, a scatter plot, and/or a heat map) to visualize the summarized multivariate time series data. More specifically, according to one embodiment, the manifold regularization program 108A, 108B may receive a representation of multivariate time series data, which may be represented by the formula:

X∈ [symbol] ^{M×N}
where M is a number of metrics/features and N is a number of data time points associated with the input data,
   Thereafter, the manifold regularization program 108A, 108B may extract overlapping, sliding window samples from X, where n is the length of the sliding window. Given, the window size n, overlap size l, and the length of the input time sequence data N, the number of valid overlapping samples can be computed as N′=floor (1+(N−n)/l). Each sliding window is then encoded into a k dimensional feature which may be represented in the formula:

z∈ [symbol] ^{k}

To further visualize different states, transitions and loops in the data, the manifold regularization program 108A, 108B may also perform principal component analysis (PCA) on the embeddings of the time series data to reduce the dimension of an embedding space.

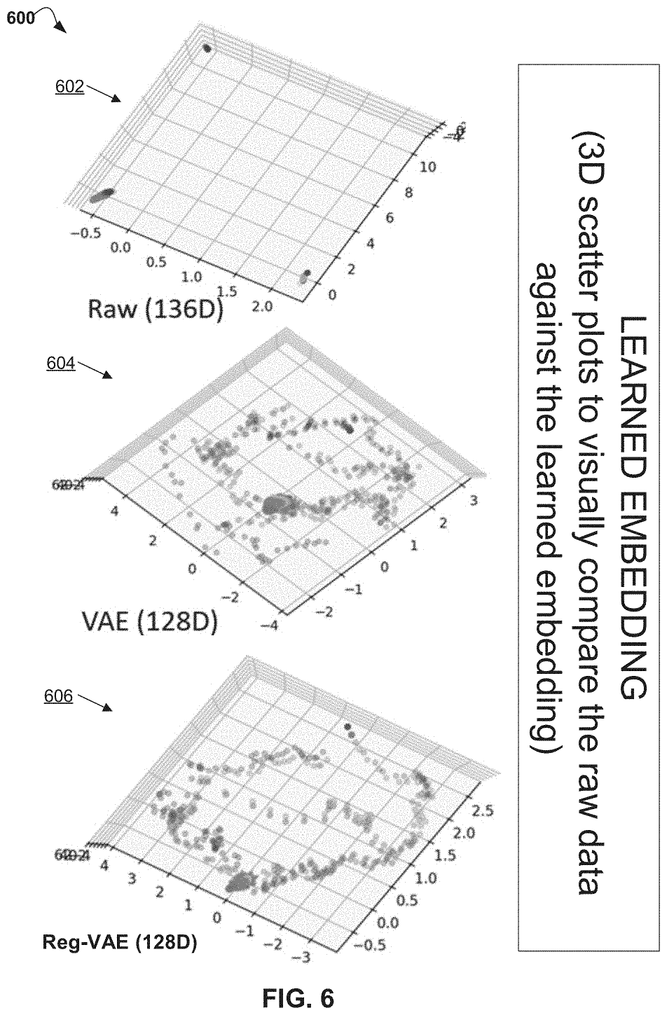

Then, according to one embodiment, and as depicted in FIG. 6, the manifold regularization program 108A, 108B may use a plotting technique, such as a scatter plot 600, to plot a sequence of 3D points that may represent data points associated with the input data 602. According to one embodiment, the plotted data points in the scatter plot may be color coded (not shown) to represent a time associated with the data points. As shown in FIG. 6, results associated with embedding based on VAE alone 604 and embedding based on the regularized-VAE 606, taken from raw data 602, are depicted (i.e. the two plots are based on the same monitored data with respect to a same time period, for example, monitored data associated with one or more computer servers for a period of 3 months). As depicted in FIG. 6, the plotted data points associated with the scattered plot based on the VAE alone 604 are not continuous (i.e. random) and/or does not present a temporal relation between the data. Compared to the embedding obtained from the VAE alone 604, the embedding trained with regularized-VAE 606 exhibits a more periodic and smooth/continuous pattern between data points, where the embedded time steps from the regularized-VAE is continuous with respect to time, and the data captured between different time periods are close to each other in the embedding space. As such, the regularized-VAE generates a smooth embedding and captures important invariant properties of the time sequence data.

It may be appreciated that FIGS. 2-6 provide only illustrations of one implementation and does not imply any limitations with regard to how different embodiments may be implemented. Many modifications to the depicted environments may be made based on design and implementation requirements.

The present invention may be a system, a method, and/or a computer program product. The computer program product may include a computer readable storage medium (or media) having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

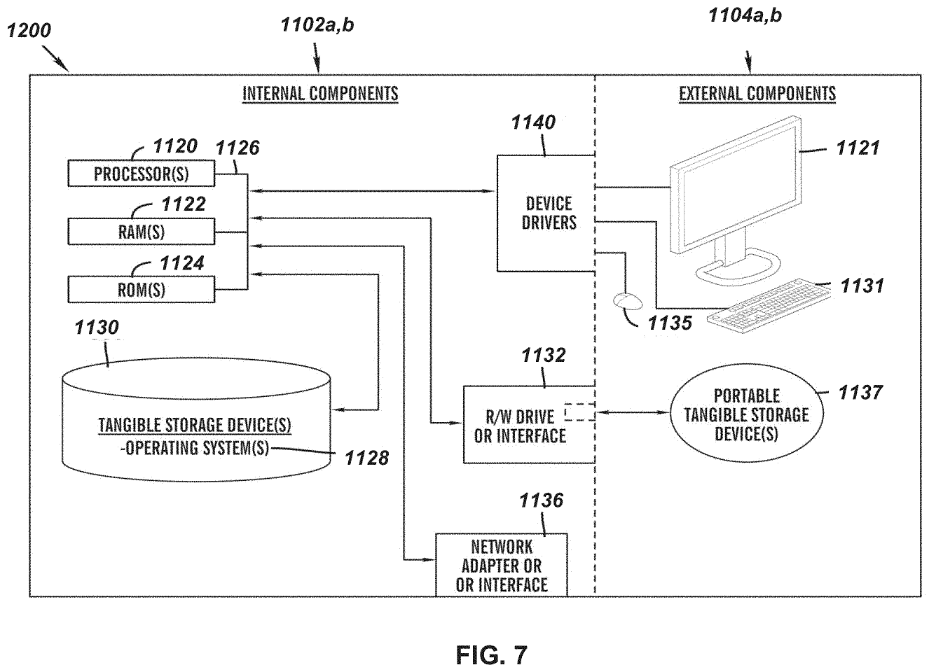

FIG. 7 is a block diagram 1100 of internal and external components of computers depicted in FIG. 1 in accordance with an illustrative embodiment of the present invention. It should be appreciated that FIG. 7 provides only an illustration of one implementation and does not imply any limitations with regard to the environments in which different embodiments may be implemented. Many modifications to the depicted environments may be made based on design and implementation requirements.

Data processing system 110, 1104 is representative of any electronic device capable of executing machine-readable program instructions. Data processing system 1102, 1104 may be representative of a smart phone, a computer system, PDA, or other electronic devices. Examples of computing systems, environments, and/or configurations that may represented by data processing system 1102, 1104 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

User client computer 102 (FIG. 1), and network server 112 (FIG. 1) include respective sets of internal components 1102 a, b and external components 1104 a, b illustrated in FIG. 7. Each of the sets of internal components 1102 a, b includes one or more processors 1120, one or more computer-readable RAMs 1122, and one or more computer-readable ROMs 1124 on one or more buses 1126, and one or more operating systems 1128 and one or more computer-readable tangible storage devices 1130. The one or more operating systems 1128, the software program 114 (FIG. 1) and the manifold regularization program 108A (FIG. 1) in client computer 102 (FIG. 1), and the manifold regularization program 108B (FIG. 1) in network server computer 112 (FIG. 1) are stored on one or more of the respective computer-readable tangible storage devices 1130 for execution by one or more of the respective processors 1120 via one or more of the respective RAMs 1122 (which typically include cache memory). In the embodiment illustrated in FIG. 7, each of the computer-readable tangible storage devices 1130 is a magnetic disk storage device of an internal hard drive. Alternatively, each of the computer-readable tangible storage devices 1130 is a semiconductor storage device such as ROM 1124, EPROM, flash memory or any other computer-readable tangible storage device that can store a computer program and digital information.

Each set of internal components 1102 a, b, also includes a R/W drive or interface 1132 to read from and write to one or more portable computer-readable tangible storage devices 1137 such as a CD-ROM, DVD, memory stick, magnetic tape, magnetic disk, optical disk or semiconductor storage device. A software program, such as a manifold regularization program 108A and 108B (FIG. 1), can be stored on one or more of the respective portable computer-readable tangible storage devices 1137, read via the respective R/W drive or interface 1132, and loaded into the respective hard drive 1130.

Each set of internal components 1102 a, b also includes network adapters or interfaces 1136 such as a TCP/IP adapter cards, wireless Wi-Fi interface cards, or 3G or 4G wireless interface cards or other wired or wireless communication links. The manifold regularization program 108A (FIG. 1) and software program 114 (FIG. 1) in client computer 102 (FIG. 1), and the manifold regularization program 108B (FIG. 1) in network server 112 (FIG. 1) can be downloaded to client computer 102 (FIG. 1) from an external computer via a network (for example, the Internet, a local area network or other, wide area network) and respective network adapters or interfaces 1136. From the network adapters or interfaces 1136, the manifold regularization program 108A (FIG. 1) and software program 114 (FIG. 1) in client computer 102 (FIG. 1) and the manifold regularization program 108B (FIG. 1) in network server computer 112 (FIG. 1) are loaded into the respective hard drive 1130. The network may comprise copper wires, optical fibers, wireless transmission, routers, firewalls, switches, gateway computers, and/or edge servers.

Each of the sets of external components 1104 a, b can include a computer display monitor 1121, a keyboard 1131, and a computer mouse 1135. External components 1104 a, b can also include touch screens, virtual keyboards, touch pads, pointing devices, and other human interface devices. Each of the sets of internal components 1102 a, b also includes device drivers 1140 to interface to computer display monitor 1121, keyboard 1131, and computer mouse 1135. The device drivers 1140, R/W drive or interface 1132, and network adapter or interface 1136 comprise hardware and software (stored in storage device 1130 and/or ROM 1124).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

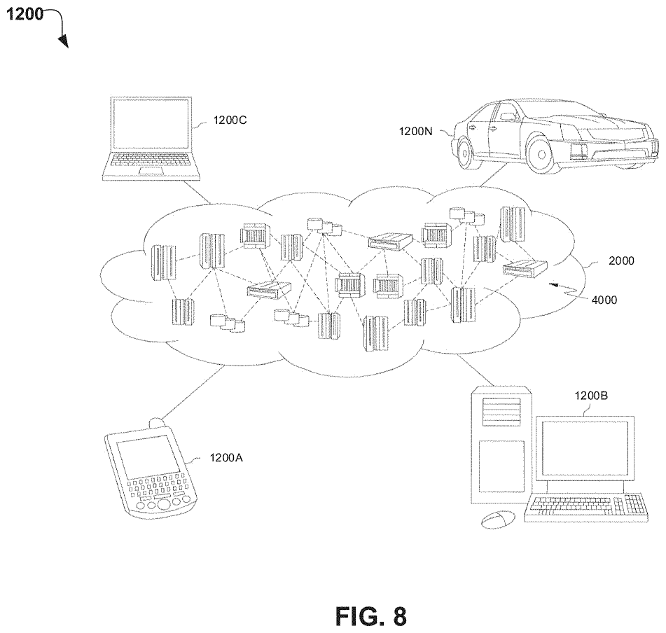

Referring now to FIG. 8, illustrative cloud computing environment 1200 is depicted. As shown, cloud computing environment 1200 comprises one or more cloud computing nodes 4000 with which local computing devices used by cloud consumers, such as, for example, personal digital assistant (PDA) or cellular telephone 1200A, desktop computer 1200B, laptop computer 1200C, and/or automobile computer system 1200N may communicate. Nodes 4000 may communicate with one another. They may be grouped (not shown) physically or virtually, in one or more networks, such as Private, Community, Public, or Hybrid clouds as described hereinabove, or a combination thereof. This allows cloud computing environment 2000 to offer infrastructure, platforms and/or software as services for which a cloud consumer does not need to maintain resources on a local computing device. It is understood that the types of computing devices 1200A-N shown in FIG. 8 are intended to be illustrative only and that computing nodes 4000 and cloud computing environment 2000 can communicate with any type of computerized device over any type of network and/or network addressable connection (e.g., using a web browser).

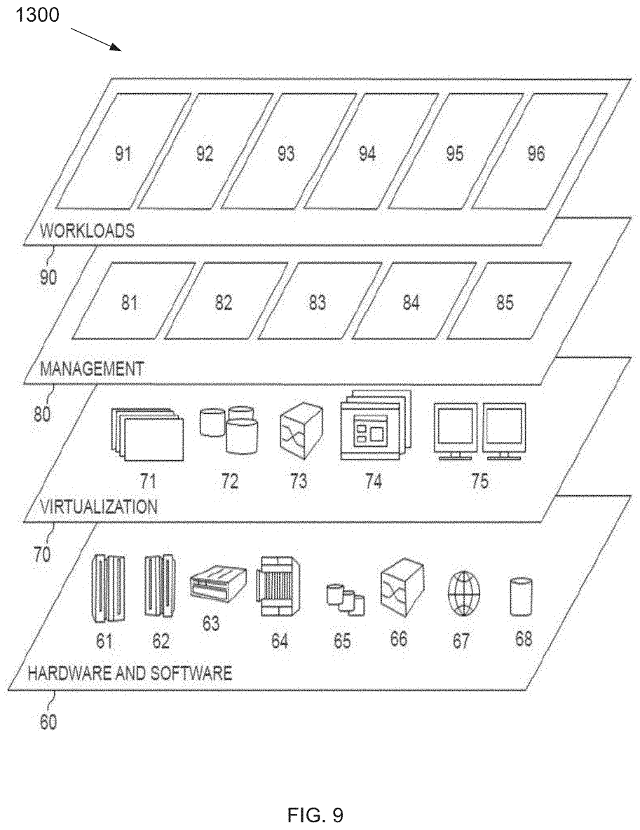

Referring now to FIG. 9, a set of functional abstraction layers 1300 provided by cloud computing environment 1200 (FIG. 8) is shown. It should be understood in advance that the components, layers, and functions shown in FIG. 9 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and manifold regularization 96. A manifold regularization program 108A, 108B (FIG. 1) may be offered “as a service in the cloud” (i.e., Software as a Service (SaaS)) for applications running on computing devices 102 (FIG. 1) and may, on a computing device, adjust an on-screen virtual keyboard layout to compensate for a user's hand tremors.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for generating and displaying an embedding of multivariate time series data in an embedded space, the method comprising:
optimizing a generative deep learning neural network model by adding a regularization term to train the generative deep learning neural network model, wherein the regularization term maintains a temporal relationship between data points associated with the multivariate time series data when representing the data points of the multivariate time series data in an embedded space; and
in response to receiving the multivariate time series data as input, applying the optimized generative deep learning neural network model to the input, and representing and displaying the multivariate time series data in the embedded space such that the temporal relationship between the data points from the input is captured by and presented in the representation, wherein the representation comprises an embedding of the multivariate time series data in the embedded space.

2. The method of claim 1, wherein the deep learning neural network generative model is a variational autoencoder (VAE) and the regularization term is a manifold regularization term.

3. The method of claim 2, further comprising:
using the variational autoencoder (VAE) along with the manifold regularization term to learn a representation of the multivariate time series data.

4. The method of claim 1, wherein the regularization term is based on a Laplacian operator.

5. The method of claim 3, wherein using the variational autoencoder (VAE) along with the manifold regularization term to learn a representation of the multivariate time series data further comprises:
using the variational autoencoder (VAE) along with the manifold regularization term to learn a representation of contiguous blocks of time series data associated with the multivariate time series data by applying overlapping time sliding windows on the multivariate time series data.

6. The method of claim 1, wherein representing the multivariate time series data in the embedded space further comprises:
visually representing and correlating anomalies and changes in patterns associated with the multivariate time series data.

7. The method of claim 6, wherein representing the temporal relationship between the data points in the reconstruction further comprises:
plotting the data points having a temporal relationship on the embedded space in a continuous pattern.

8. A computer system for generating and displaying an embedding of multivariate time series data in an embedded space, comprising:
one or more processors, one or more computer-readable memories, one or more computer-readable tangible storage devices, and program instructions stored on at least one of the one or more storage devices for execution by at least one of the one or more processors via at least one of the one or more memories, wherein the computer system is capable of performing a method comprising:
optimizing a generative deep learning neural network model by adding a regularization term to train the generative deep learning neural network model, wherein the regularization term maintains a temporal relationship between data points associated with the multivariate time series data when representing the data points of the multivariate time series data in an embedded space; and
in response to receiving the multivariate time series data as input, applying the optimized generative deep learning neural network model to the input, and representing and displaying the multivariate time series data in the embedded space such that the temporal relationship between the data points from the input is captured by and presented in the representation, wherein the representation comprises an embedding of the multivariate time series data in the embedded space.

9. The computer system of claim 8, wherein the deep learning neural network generative model is a variational autoencoder (VAE) and the regularization term is a manifold regularization term.

10. The computer system of claim 9, further comprising:
using the variational autoencoder (VAE) along with the manifold regularization term to learn a representation of the multivariate time series data.

11. The computer system of claim 8, wherein the regularization term is based on a Laplacian operator.

12. The computer system of claim 9, wherein using the variational autoencoder (VAE) along with the manifold regularization term to learn a representation of the multivariate time series data further comprises:
using the variational autoencoder (VAE) along with the manifold regularization term to learn a representation of contiguous blocks of time series data associated with the multivariate time series data by applying overlapping time sliding windows on the multivariate time series data.

13. The computer system of claim 8, wherein representing the multivariate time series data in the embedded space further comprises:
visually representing and correlating anomalies and changes in patterns associated with the multivariate time series data.

14. The computer system of claim 8, wherein representing the temporal relationship between the data points in the reconstruction further comprises:
plotting the data points having a temporal relationship on the embedded space in a continuous pattern.

15. A computer program product for generating and displaying an embedding of multivariate time series data in an embedded space, comprising:
one or more tangible computer-readable storage devices and program instructions stored on at least one of the one or more tangible computer-readable storage devices, the program instructions executable by a processor, the program instructions comprising:
program instructions to optimize a generative deep learning neural network model by adding a regularization term to train the generative deep learning neural network model, wherein the regularization term maintains a temporal relationship between data points associated with the multivariate time series data when representing the data points of the multivariate time series data in an embedded space; and
program instructions to, in response to receiving the multivariate time series data as input, apply the optimized generative deep learning neural network model to the input, and represent and display the multivariate time series data in the embedded space such that the temporal relationship between the data points from the input is captured by and presented in the representation, wherein the representation comprises an embedding of the multivariate time series data in the embedded space.

16. The computer program product of claim 15, wherein the deep learning neural network generative model is a variational autoencoder (VAE) and the regularization term is a manifold regularization term.

17. The computer program product of claim 16, further comprising:
program instructions to use the variational autoencoder (VAE) along with the manifold regularization term to learn a representation of the multivariate time series data.

18. The computer program product of claim 17, wherein the program instructions to use the variational autoencoder (VAE) along with the manifold regularization term to learn a representation of the multivariate time series data further comprises:
program instructions to use the variational autoencoder (VAE) along with the manifold regularization term to learn a representation of contiguous blocks of time series data associated with the multivariate time series data by applying overlapping time sliding windows on the multivariate time series data.

19. The computer program product of claim 15, wherein the program instructions to represent the multivariate time series data in the embedded space further comprises:
program instructions to visually represent and correlate anomalies and changes in patterns associated with the multivariate time series data.

20. The computer program product of claim 15, wherein the program instructions to represent the temporal relationship between the data points in the reconstruction further comprises:
program instructions to plot the data points having a temporal relationship on the embedded space in a continuous pattern.
